(19) United States
(12) Patent Application Publication
(10) Pub. No.: US 2026/0089170 A1
(43) Pub. Date: Mar. 26, 2026

(54) DOMAIN NAME AND DNS RECORD ANALYSIS FOR DNS TUNNELING DETECTION

(71) Applicant: Palo Alto Networks, Inc., Santa Clara, CA (US)

(72) Inventors: Shu Wang, San Jose, CA (US); Ruian Duan, Santa Clara, CA (US); Daiping Liu, Sunnyvale, CA (US)

(21) Appl. No.: 18/898,162

(22) Filed: Sep. 26, 2024

(51) Int. Cl. H04L 9/40; H04L 61/4511

(52) U.S. Cl. CPC H04L 63/14; H04L 61/4511

(57) ABSTRACT

A DNS tunneling detector inspects domain names and DNS records in detected DNS traffic for indicators of DNS tunneling. For identified domain names, the detector parses the domain name into its components and categorizes one or more of the components to generate a pattern covering the domain name. The detector retrieves recent passive DNS data comprising domain names having a same root domain as the identified domain name and generates additional patterns for those domain names. The detector aggregates the generated patterns, which can yield discovery of encoded text in domain name components. The detector decodes the corresponding domain name components and determines if the decoded text is meaningful. For certain types of detected DNS records, the detector determines if the DNS record contents are encoded and, if so, decodes the contents to obtain the text encoded in the DNS record, and determines if the decoded text is meaningful.

### BACKGROUND

The disclosure generally relates to network architectures or network communication protocols for network security (e.g., CPC subclass H04L 63/00) and to security arrangements for protecting computers, components thereof, programs or data against unauthorized activity (e.g., CPC subclass G06F 21/00).

The Domain Name System (DNS) is a hierarchical and distributed naming system that maps human-readable domain names to Internet Protocol (IP) addresses of websites and other Internet-accessible resources. Such resources can be requested and retrieved via DNS requests and responses. A DNS request typically involves a query comprising a domain name of a requested resource from a client (such as a web browser) to a DNS resolver, which then contacts authoritative name servers to retrieve the corresponding IP address. A DNS response contains the requested IP address and additional information, such as the Time-to-Live (TTL), which dictates how long the information should be cached. DNS resource records, commonly abbreviated as RRs, store information about domain names and IP addresses and are used to resolve DNS queries. Resource records are the units of information in DNS zone files. Resource records include fields indicating an owner associated with the record, record type, class, time to live (TTL), and resource data.

DNS tunneling attacks exploit the DNS protocol to transmit malicious traffic between a target system and an external server. By embedding malicious payloads within DNS requests and responses, attackers can use DNS tunneling for data infiltration, such as sending commands to malware, and exfiltration, such as extracting sensitive data from the target system. DNS tunneling attacks can often evade detection by conventional network security measures since the DNS traffic comprising malicious code appears to be legitimate DNS traffic.

### BRIEF DESCRIPTION OF THE DRAWINGS

Embodiments of the disclosure may be better understood by referencing the accompanying drawings.

FIG. 1 is a conceptual diagram of analyzing a domain name for possible DNS tunneling.

FIG. 2 is a flowchart of example operations for analyzing DNS traffic for indicators of DNS tunneling.

FIGS. 3A-3B are a flowchart of example operations for analyzing a domain name for indicators of DNS tunneling.

FIG. 4 is a flowchart of example operations for generating a pattern from a domain name.

FIGS. 5A-5B are a flowchart of example operations for aggregating patterns across domain names to generate an aggregate pattern covering the domain names.

FIG. 6 is a flowchart of example operations for analyzing a DNS record for indicators of DNS tunneling.

FIG. 7 depicts an example computer system with a DNS tunneling detector.

### DESCRIPTION

The description that follows includes example systems, methods, techniques, and program flows to aid in understanding the disclosure and not to limit claim scope.

Well-known instruction instances, protocols, structures, and techniques have not been shown in detail for conciseness.

### Introduction

Current approaches for detecting DNS tunneling involve analyzing patterns of subdomains identified in DNS traffic and using signatures of known malicious domains. For pattern-based analysis of subdomains, subdomains with greater lengths and/or higher entropies may be flagged as being indicative of DNS tunneling. Known malicious domain signatures are signatures of root domains known to be malicious, so any domain names based on a root domain known to be malicious can be flagged as likely to be used for DNS tunneling. However, these approaches have drawbacks. Decoding and analyzing data encoded in DNS traffic in real-time is challenging, so difficulties can arise in distinguishing between benign and malicious data encoded in detected DNS traffic.

Lastly, identifying new or evolving tunneling techniques poses a challenge, so malicious traffic employing DNS tunneling may evade detection by DNS tunneling detectors that have not yet been configured to detect DNS tunneling with newer or more recently developed techniques.

### Overview

DNS tunneling detection techniques disclosed herein overcome the aforementioned challenges. A DNS tunneling detector inspects domain names and DNS records in detected DNS traffic for indicators of DNS tunneling. The detector identifies a domain name indicated in a DNS request or response and analyzes the domain name to determine if it corresponds to a known DNS tunneling technique detectable with pattern-based methods. For enhanced evaluation of the domain name, the detector then parses the domain name into its components and categorizes at least a subset of the components based on their types and/or lengths to generate a pattern covering the domain name. The detector then retrieves passive DNS data for a recent timeframe (e.g., the last hour) that indicate domain names that share a root domain with the identified domain name. The detector arranges the domain names chronologically and, for each domain name identified from the passive DNS data, parses the domain name and generates a pattern covering the domain name based on categorization of one or more components by type and/or length. Examples of component types include numeric and hexadecimal values.

The detector then aggregates the patterns generated across the chronologically arranged domain names, which can yield discovery of counter patterns, fixed values, or encoded text of a respective encoding scheme (e.g., American Standard Code for Information Interchange (ASCII) or Base64) across the domain names. If the aggregate pattern indicates that the covered domain names comprise encoded text, the detector decodes the corresponding components of the domain names and maintains the decoded text in the previously determined chronological order. The detector prompts a language model to evaluate the resulting decoded text and determine if it is meaningful (i.e., has meaning in a semantic sense), as meaningful text encoded in subdomains across domain names identified in DNS traffic detected within a relatively short timeframe can be indicative of DNS tunneling. For DNS traffic comprising DNS records (i.e., DNS responses), the detector also identifies records that have one of a set of designated types of DNS records that may comprise encoded text. For those records that are identified, the detector determines if the contents of the DNS record are encoded and, if so, decodes the contents to obtain the text encoded in the DNS record. The detector prompts a language model to determine if the decoded text is meaningful. The detector indicates the resulting pattern, any text encoded in the DNS traffic (whether in a DNS request or DNS record included in a DNS response) and whether the text is meaningful, whether the domain name matches a known DNS tunneling pattern, and whether the detected domain name is likely to correspond to DNS tunneling based on these determined factors.

### Example Illustrations

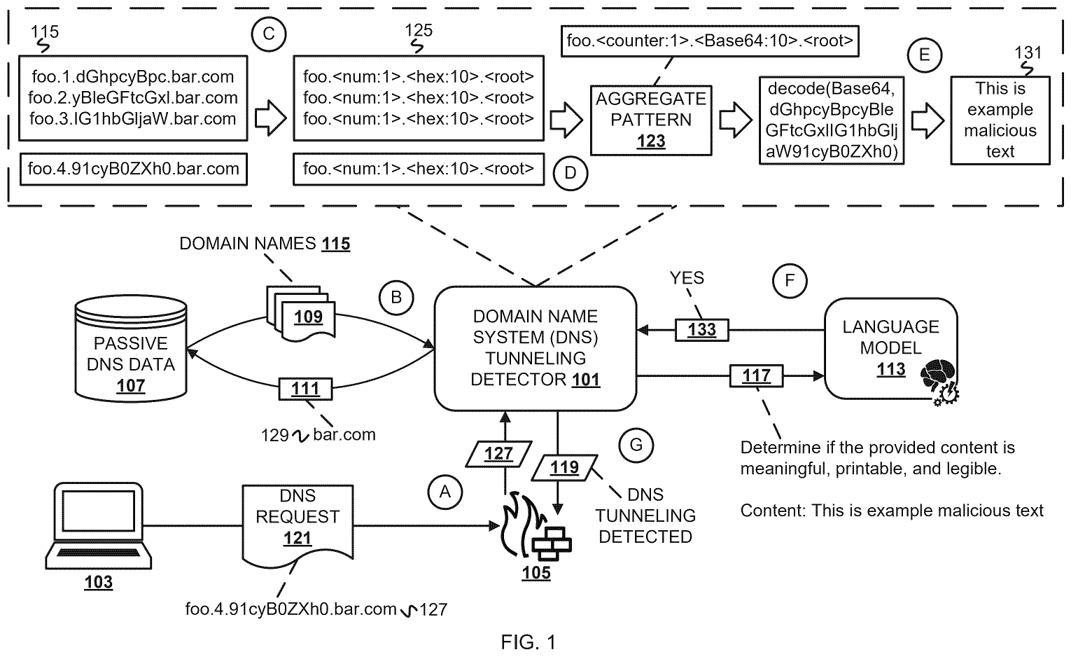

FIG. 1 is a conceptual diagram of analyzing a domain name for possible DNS tunneling. A DNS tunneling detector (“detector”) 101 analyzes DNS requests and responses detected by a firewall 105. The detector 101 can execute as an external (e.g., cloud-based) service with which the firewall 105 communicates over a secure connection or can execute as part of the firewall 105. This example depicts DNS tunneling detection by the detector 101 as in-line with respect to the flow of network traffic.

FIG. 1 is annotated with a series of letters A-G. Each letter represents a stage of one or more operations. Although these stages are ordered for this example, the stages illustrate one example to aid in understanding this disclosure and should not be used to limit the claims. Subject matter falling within the scope of the claims can vary from what is illustrated.

At stage A, the firewall 105 detects a DNS request 121 sent by a client device 103. The DNS request 121 indicates a domain name 127, which is given as an example domain name “foo.4.91cyBOZXh0.bar.com”. The firewall 105 at least communicates the domain name 127 to the detector 101, but cybersecurity appliances in implementations may instead communicate the DNS request 121 as a whole to the detector 101. The detector 101 obtains the domain name 127.

At stage B, the detector 101 obtains recent passive DNS data for domain names having a same root domain as the domain name 127. The detector 101 can determine a root domain of the domain name 127 by identifying a top-level domain (TLD) in the domain name 127, or “. com” in this example, and the component(s) of the domain name in the next hierarchical level (e.g., based on determining the component that immediately precedes the TLD). The detector 101 determines that a root domain 129 of the domain name 127 of “foo.4.91cyBOZXh0.bar.com” is “bar.com”. The detector 101 submits a query 111 to a passive DNS database 107 for passive DNS data indicating the root domain 129. The passive DNS database 107 can be a database that is managed by a cybersecurity provider that manages/provides the firewall 105 and maintains passive DNS data captured for the network secured by the firewall 105 (not depicted in FIG. 1). The query 111 submitted to the passive DNS database 107 also indicates a timeframe for which passive DNS data should be retrieved. Since DNS tunneling attacks occurring over a sequence of DNS requests and responses are generally carried out during a relatively short time period, the detector 101 queries the passive DNS database 107 for passive DNS data indicating the root domain 129 that was captured during a timeframe reflective of this shorter time period, such as passive DNS data having timestamps falling within the last hour. The detector 101 obtains passive DNS data 109 in response to the query 111. The passive DNS data 109 indicates a plurality of domain names 115, each of which comprises the root domain 129. FIG. 1 depicts the domain names 115 as comprising example domain names “foo.1.dGhpcyBpc.bar.com”, “foo.2.yBleGFtcGxl.bar.com”, and “foo.3.IG1hbGljaW.bar.com”.

At stage C, the detector 101 generates patterns 125 from the domain name 127 and the domain names 115 (collectively “the domain names 115, 127”). The detector 101 arranges the domain names 115, 127 chronologically (e.g., based on timestamps associated therewith) and parses each of the domain names 115, 127 into its components (also called “labels” in the art), such as based on dot separators. Since pattern generation focuses on subdomains, the detector 101 may omit the root domain 129 from parsing. To illustrate, if the root domain 129 is omitted from parsing, the detector 101 parses the domain name “foo.1.dGhpcyBpc.bar.com” into its components that comprise “foo”, “1”, “dGhpcyBpc”, and “bar.com”; if the root domain 129 is also parsed, the root domain will be split into “bar” and “com”.

The detector 101 then generates a pattern for each of the domain names 115, 127 based on evaluation of each component identified as a result of parsing. For each component of a respective one of the domain names 115, 127, the detector 101 evaluates the component to determine if the component matches a category recognized by the detector 101. Examples of categories include numeric values, sequences of hexadecimal values, and character strings. The detector 101 can be configured with regular expressions corresponding to the defined categories based on which the detector 101 evaluates each domain name component to determine if there is a match. If a domain name component matches a regular expression defined for a respective category, the detector 101 can determine an abstracted representation of the component that identifies the category and a length of the component and include the abstracted representation of the component in the pattern. To illustrate, in FIG. 1, the detector 101 determines that the components “1”, “2,” “3”, and “4” of the domain names 115, 127 match a regular expression defined for single digit numeric values and determines an abstracted version of these components represented as “<num:1>”. For the components “dGhpcyBpc”, “yBleGFtcGxl”, “IG1hbGljaW”, and “91cyBOZXh0”, the detector 101 determines that the components match a regular expression defined for variable length hexadecimal values and determines an abstracted representation of these components of “<hex:10>”. Additionally, whether to categorize components based on an abstraction thereof can be based on their lengths and character types as reflected in the regular expressions. To illustrate, the detector 101 can generate abstractions from components determined to only comprise characters of the alphabet (e.g., the English alphabet) having a length longer than a first threshold (e.g., longer than seven characters) and from components comprising both letters and numbers that are longer than a second threshold (e.g., longer than four characters). If the component length does not exceed the respective threshold, as is the case with “foo” in this example, the detector 101 retains the component in the pattern without abstraction as a fixed padding. The thresholds for components that inform whether to abstract a component for its representation in a pattern can be set based on expert/domain knowledge and/or based on statistics determined from known domain name samples. The patterns 125 that result comprise a same pattern for each of the domain names 115, 127 in this example, or the pattern “foo.<num:1>.<hex:10>.<root>”.

At stage D, the detector 101 aggregates the patterns 125 to generate an aggregate pattern 123. The detector 101 analyzes the patterns 125 and the domain names 115, 127 to determine how to consolidate the patterns 125 into a single aggregate pattern that covers the domain names 115, 127. The detector 101 analyzes each sub-pattern comprising one pattern component at a same domain name location across the domain names 115, 127 and the patterns 125. The “location” in a domain name refers to location of components with respect to the number and ordering of components in the domain name. To illustrate, for the domain name “foo.1.dGhpcyBpc.bar.com”, “foo” is the first component, “1” is the second component, “dGhpcyBpc” is the third component, and so on. For each set of sub-patterns at a same location in the patterns 125 (e.g., the sub-pattern “<num:1>” at the second location in each of the patterns 125), the detector 101 determines a component type indicated by the sub-pattern. Since the first sub-pattern of each of the patterns 125 is a fixed string value rather than an abstracted type, the detector 101 includes this string, or “foo”, as the first sub-pattern of the aggregate pattern 123. The detector 101 also includes the indication of the root domain 129 “<root>” in the last component of the aggregate pattern 123 since this sub-pattern is also consistent across the patterns 125.

Some component types can be subject to further evaluation to determine if the respective sub-pattern can be refined or made more descriptive. For instance, the detector 101 can maintain criteria for sub-pattern refinement indicating one or more component types represented in a sub-pattern. Such component types include decimal values, which may be a constant value across domain names or increasing across domain names as a counter value, or types that may correspond to encoded text, such as hexadecimal character strings. For the second sub-pattern in each of the patterns 125, the detector 101 determines that the components represented by these sub-patterns are single digit numeric values. The detector 101 thus evaluates the components at this location in each of the domain names 115, 127 and determines that the components comprise a value that increments by one in each of the domain names 115, 127 in chronological order. The detector 101 thus aggregates these sub-patterns into a single sub-pattern indicating that the component at that location of the domain names 115, 127 comprises a counter value and updates the aggregate pattern 123 at the third component location with this sub-pattern “<counter:1>”.

The detector 101 also determines from the patterns 125 that the third sub-pattern indicates that the third component of corresponding ones of the domain names 115, 127 comprises a hexadecimal value with a length of 10. Hexadecimal values may correspond to encoded text, so the detector 101 evaluates each of the respective components of the domain names 115, 127 based on one or more detection patterns such as regular expressions corresponding to one or more encoding schemes. These detection patterns are used for detecting encoded text according to a certain encoding scheme, such as Base32, Base64, and/or ASCII. If each of the components of the domain names 115, 127 corresponding to this sub-pattern of the patterns 125 matches one of the encoding detection patterns, the detector 101 incorporates a sub-pattern in the aggregate pattern 123 indicating that components at that location in the domain names covered by the aggregate pattern 123 (i.e., the domain names 115, 127) comprise text encoded with that encoding scheme. For this example, the detector 101 determines that the components represented by the sub-pattern “<hex:10>” in the domain names 115, 127, or the components “dGhpcyBpc”, “yBleGFtcGxl”, “IG1hbGljaW”, and “91cyBOZXh0”, match an encoding detection pattern for Base64 encoding. The detector 101 updates the third sub-pattern of the aggregate pattern 123 to indicate that corresponding components of covered domain names comprise Base64 encoded text, with this example depicting the sub-pattern “<Base64:10>”.

At stage E, the detector 101 decodes the components of the domain names 115, 127 designated as corresponding to encoded text in the aggregate pattern 123. The detector 101 evaluates the aggregate pattern 123 to determine if it comprises a sub-pattern indicating that the covered domain names comprise text encoded according to a specified encoding scheme at the corresponding location in each domain name. In this example, the aggregate pattern 123 indicates that the third component of each of the domain names 115, 127 comprises Base64 encoded text. The detector 101 thus concatenates the character strings that form each of these components across domain names to generate a concatenated character string, depicted in this example as “dGhpcyBpcyBleGFtcGxlIG1hbGljaW91cyBOZXh0”. The detector 101 then decodes this aggregated character string with a Base64 decoder to obtain decoded text 131. The decoded text 131 in this example comprises the text “This is example malicious text”.

At stage F, the detector 101 prompts a language model 113 to determine if the decoded text 131 is meaningful. The detector 101 generates a prompt 117 that comprises the decoded text 131 and a task instruction to determine if the provided text is meaningful, printable, and legible. Text should be considered meaningful if it makes sense from a semantic perspective and is understandable. The detector 101 submits the prompt 117 to the language model 113, which may be a LLM or other foundation model to which prompts can be submitted via an application programming interface (API) or other interface. The detector 101 obtains a response 133 from the language model indicating that the decoded text 131 was determined to be meaningful.

At stage G, the detector 101 indicates that the domain name 127 is indicative of DNS tunneling. The detector 101 detects DNS tunneling for the DNS request 121 at least because the domain name 127 indicated therein is part of a series of recently requested domain names that, when components thereof are aggregated and decoded, comprise meaningful text that is thus indicative of a DNS tunneling attempt. The detector 101 can generate a verdict 119 as a notification, alert, etc. that it communicates to the firewall 105. The verdict 119 can indicate the aggregate pattern 123, the decoded text 131, and an indication that the decoded text 131 is meaningful. The firewall 105 thus can take action based on the verdict 119, such as by blocking the DNS request 121.

The example in FIG. 1 depicts each component of the domain names 115, 127 as being the same length across domain names and thus having a same length value in the aggregate pattern 123. For instance, the components identified as hexadecimal values in the patterns 125 have a length of 10 in each of the domain names 115, 127. In implementations, lengths of components at a same location of domain names for which patterns are generated can be variable. In these cases, components of a same type with differing lengths can be represented in the aggregate pattern with a sub-pattern indicating a variable length, such as N (e.g., “<hex:N>”).

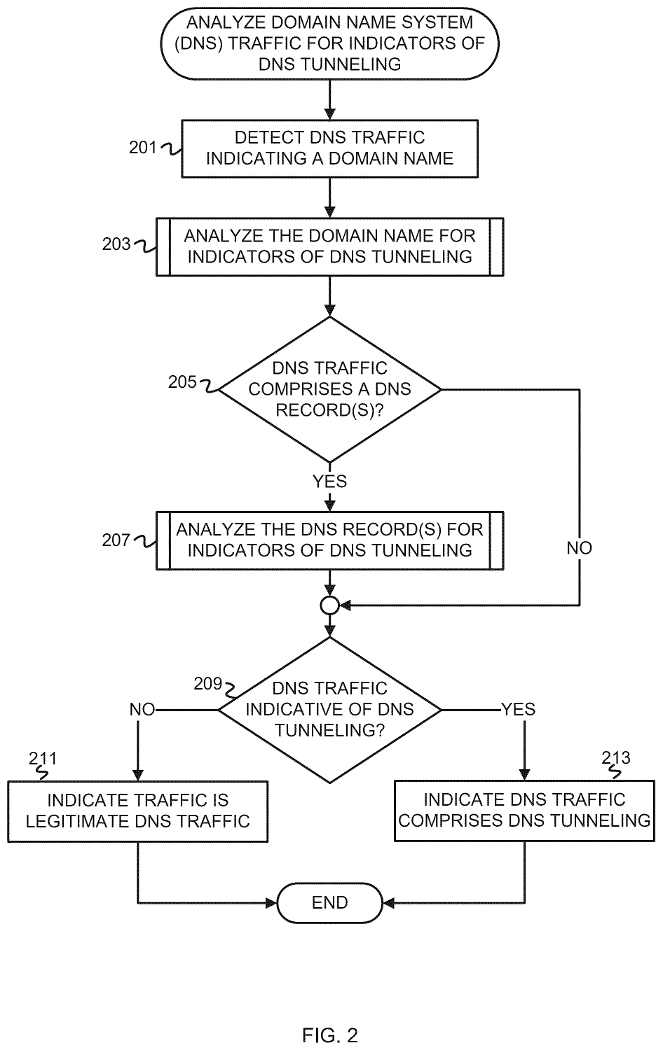

FIGS. 2-6 are flowcharts of example operations. The example operations are described with reference to a DNS tunneling detector (hereinafter “the detector”) for consistency with FIG. 1 and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 2 is a flowchart of example operations for analyzing DNS traffic for indicators of DNS tunneling. DNS traffic can include DNS requests and/or DNS responses detected by a cybersecurity appliance (e.g., a firewall).

At block 201, the detector detects DNS traffic indicating a domain name. The DNS traffic can comprise a DNS request and/or a DNS response detected as part of a DNS session. The detector can detect the DNS traffic as a result of the DNS traffic being forwarded or otherwise communicated to the detector by the cybersecurity appliance that detected the DNS traffic initially.

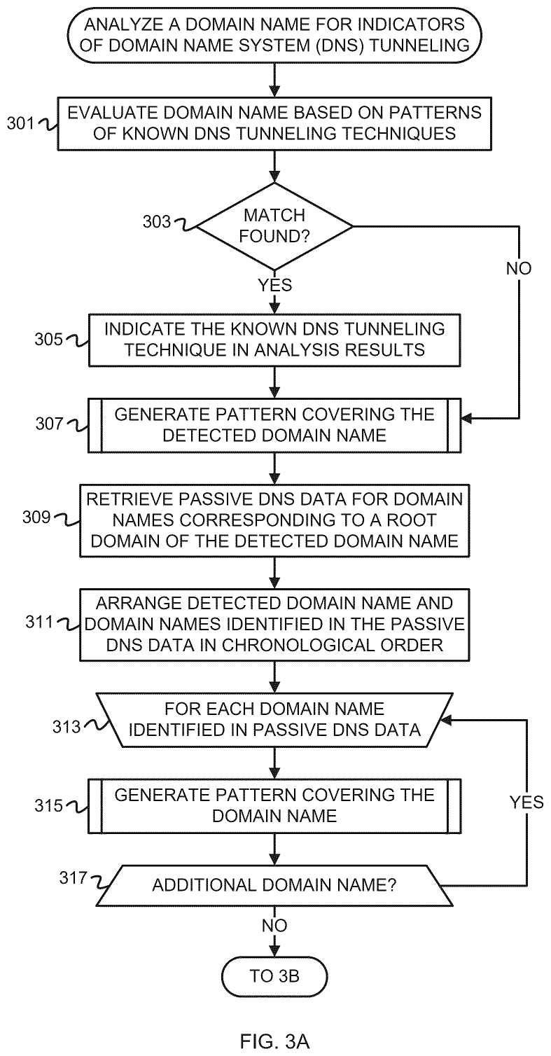

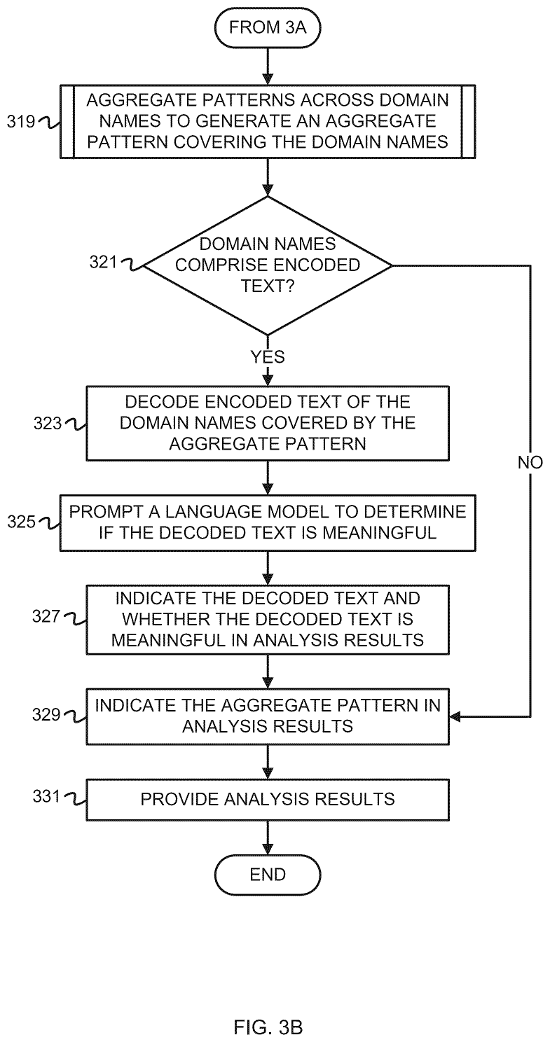

At block 203, the detector analyzes the domain name for indicators of DNS tunneling. The detector analyzes domain names identified in DNS requests and responses. The detector determines if the domain name matches a pattern (e.g., a regular expression) known to be associated with DNS tunneling and also analyzes the domain name subdomain for the presence of encoded text, a counter value, or another indicator that the domain name may be associated with DNS tunneling. The detector can further determine if any text decoded from the domain name is meaningful (i.e., has meaning semantically), such as based on prompting a language model to evaluate the text. Analysis of the domain name is described in further detail in reference to FIGS. 3A-3B.

At block 205, the detector determines if the DNS traffic comprises a DNS record(s). The DNS traffic can comprise a DNS record(s) if the DNS traffic comprises a DNS response. The detector may further determine if the DNS record(s), if any, is of a certain type, as analysis of DNS records may be limited to certain types (e.g., TXT, SRV, A, and AAAA records). If the DNS traffic comprises a DNS record(s), operations continue at block 207. If not, operations continue at block 209.

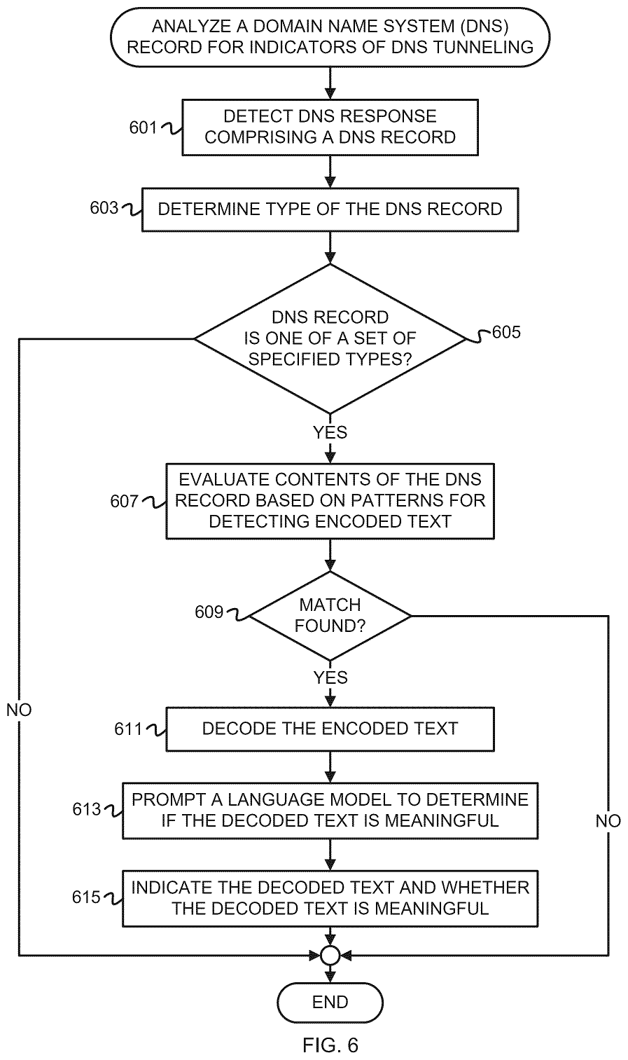

At block 207, the detector analyzes the DNS record(s) for indicators of DNS tunneling. The detector determines if the DNS record(s) comprises encoded text and can further evaluate text decoded from the DNS record to determine if it is meaningful, such as based on prompting a language model to evaluate the text. Analysis of DNS records for indicators of DNS tunneling is described in further detail in reference to FIG. 6.

At block 209, the detector determines if the DNS traffic is indicative of DNS tunneling. The detector determines if the DNS traffic is indicative of DNS tunneling based on a result of analyzing the domain name and, if the DNS traffic comprised a DNS record(s), based on a result of analyzing the DNS record(s). For instance, the detector determines that the DNS traffic is indicative of DNS tunneling if the domain name identified therein matched a pattern known to be associated with DNS tunneling, if the domain name comprises encoded text that was determined to be meaningful, and/or if the DNS record(s) comprises encoded text that was determined to be meaningful. Criteria for detection of DNS tunneling with which the detector is configured can be tunable by an organization for which the detector inspects DNS traffic, and DNS tunneling detection can be associated with a confidence level based on satisfaction of the criteria. For instance, the organization can specify via the detector configuration that DNS tunneling should be detected with a high confidence if the domain name matched a known DNS tunneling pattern or if the domain name and/or DNS record are determined to have meaningful text encoded therein. If the DNS traffic is not indicative of DNS tunneling, operations continue at block 211. If the DNS traffic is indicative of DNS tunneling, operations continue at block 213.

At block 211, the detector indicates that the DNS traffic is legitimate. The detector can indicate (e.g., to the cybersecurity appliance) that the DNS traffic is legitimate based on sending a notification or may simply allow the DNS traffic to pass if the detector is incorporated in the cybersecurity appliance.

At block 213, the detector indicates that the DNS traffic comprises DNS tunneling. The detector can indicate via a notification, alert, etc. that the DNS traffic may be associated with a DNS tunneling attack. The detector may also indicate an associated confidence level based on satisfaction of the DNS tunneling detection criteria. The cybersecurity appliance may thus block the DNS traffic.

FIGS. 3A-3B are a flowchart of example operations for analyzing a domain name for indicators of DNS tunneling. The analysis of a domain name described in FIG. 2 at block 203 can be implemented with the example operations.

At block 301, the detector evaluates the domain name based on patterns of known DNS tunneling techniques. The detector has been configured with one or more patterns (e.g., regular expressions) known to be associated with DNS tunneling, such as based on prior research and/or detection operations. For instance, the detector can determine if the domain name matches a pattern(s) for detecting DNS tunneling in network traffic generated with Cobalt Strike. DNS tunneling carried out with Cobalt Strike generated traffic often includes paddings such as “api”, “cdn”, “post” and “txt” ahead of fully qualified domain names (FQDNs). To illustrate, the detector can evaluate domain names based on the regular expression \hat{ }api\.[0-9a-f]+\.[0-9a-f]+ to detect domain names starting with “api” and that may correspond to Cobalt Strike C2 traffic. The detector evaluates the domain name against the patterns of known DNS tunneling techniques to determine if the domain name can be identified as being associated with a known tunneling technique.

At block 303, the detector determines if a match with one of the patterns of known DNS tunneling techniques was found. If a match was found, operations continue at block 305. If not, operations continue at block 307.

At block 305, the detector indicates the known DNS tunneling technique in analysis results. The detector generates analysis results indicating results of analyzing the domain name for indicators of DNS tunneling and includes in these results an indication of the known DNS tunneling technique.

At block 307, the detector generates a pattern covering the detected domain name. The detector splits (e.g., parses) the domain name into components and evaluates each component to determine if it should be abstracted in the pattern. A component is abstracted by replacing the component with an indication of its type and length.

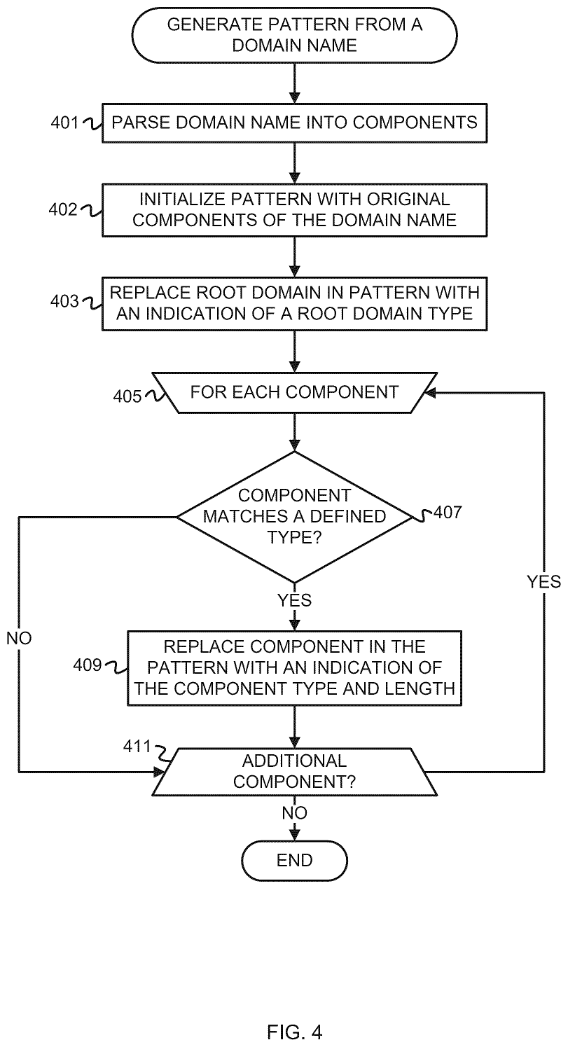

Components can be abstracted if they correspond to a known type for which a regular expression has been defined. The detector thus evaluates each component based on the regular expressions that have been defined and, if there is a match, replaces the component with an indication (e.g., a label or tag) of the corresponding type and the component length in the pattern. Components that do not match a known type can remain in their original form in the pattern. The resulting pattern thus indicates types of at least some of the components, their lengths, and their locations in the domain name with respect to order of components. Pattern generation is described in further detail in reference to FIG. 4.

At block 309, the detector retrieves passive DNS data for domain names that correspond to a root domain of the detected domain name. The detector determines a root domain of the domain name and queries passive DNS data (e.g., maintained in a database managed by the cybersecurity provider) for passive DNS data indicating a domain name that matches the root domain and having a timestamp falling within a designated timeframe. The designated timeframe can be a configurable setting of the detector or a parameter value and generally indicates a short length of time, such as a one hour timeframe. The detector thus obtains passive DNS data indicating domain names that share the root domain and were detected in DNS traffic within the timeframe (e.g., within the last hour).

At block 311, the detector arranges the detected domain name and the domain names identified in the passive DNS data in chronological order. The detector arranges the domain names in chronological order based on their associated timestamps in the passive DNS data. The detected domain name will generally be the most recently detected domain name and can be placed in the ordering accordingly.

At block 313, the detector begins iterating over each domain name that was identified in the passive DNS data. The example operations assume that passive DNS data satisfying the query were obtained, but if no passive DNS data satisfied the query and thus were not retrieved, the detector can omit the operations at blocks 315, 317 and 319.

At block 315, the detector generates a pattern covering the domain name. The detector generates the pattern in the same manner as the pattern for the detected domain name was generated as described at block 307. Pattern generation is also described in further detail in reference to FIG. 4.

At block 317, the detector determines if there is an additional domain name in the passive DNS data. If there is an additional domain name, operations continue at block 313. If not, operations continue at block 319 of FIG. 3B.

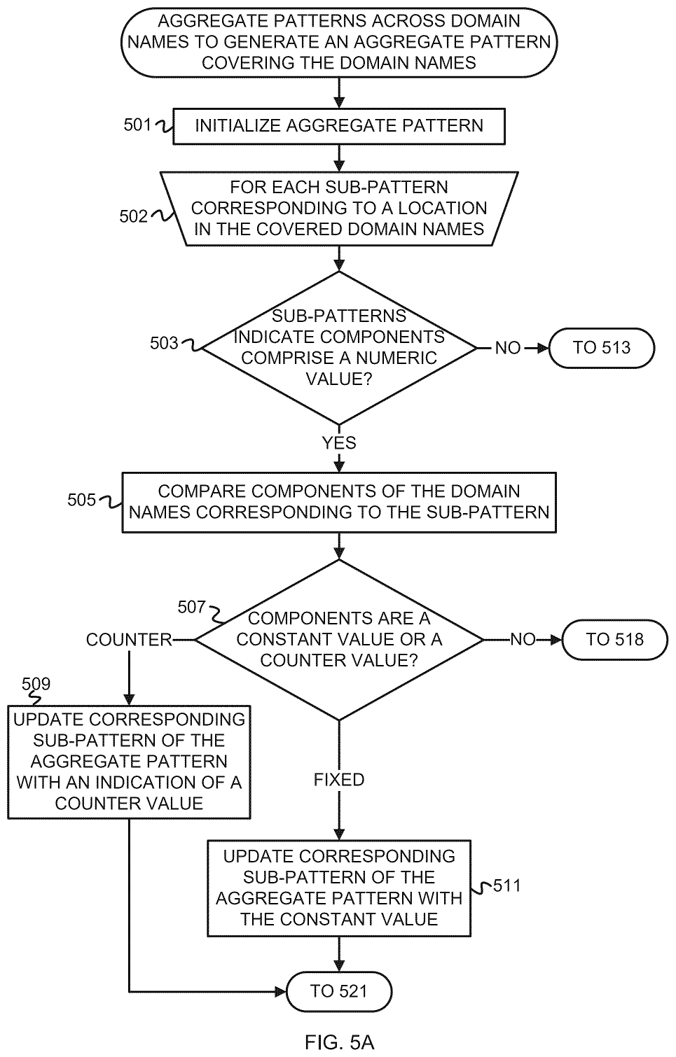

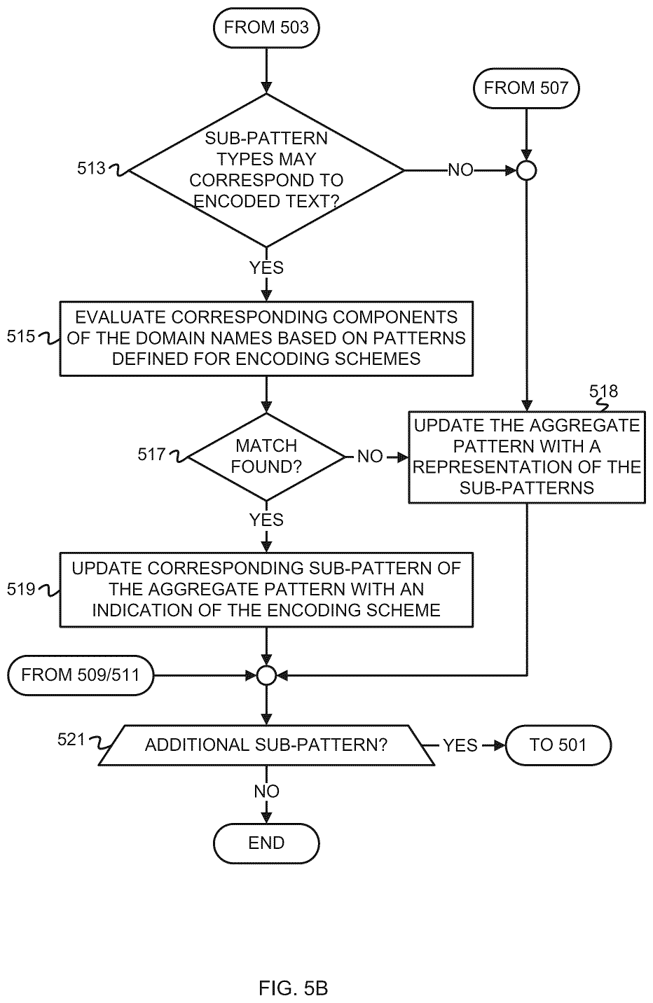

At block 319, the detector aggregates the patterns across domain names to generate an aggregate pattern that covers the domain names. The detector aggregates the patterns to generate a single pattern that covers the detected domain name and the domain names identified from passive DNS data collectively. The detector aggregates the patterns based on evaluating the patterns for trends and/or the presence of encoded text in components across domain names. The resulting aggregate pattern can comprise a sub-pattern indicating a location of encoded text in each domain name that the aggregate pattern covers and the corresponding encoding scheme. Aggregation of patterns, including to identify encoded text in domain names, is described in further detail in reference to FIGS. 5A-5B.

At block 321, the detector determines if the domain names comprise encoded text. The detector determines if the aggregate pattern comprises a sub-pattern indicating an encoding scheme and a location of encoded text in the domain names covered by the aggregate pattern. If the domain names comprise encoded text, operations continue at block 323. If not, operations continue at block 329.

At block 323, the detector decodes the encoded text of the domain names covered by the aggregate pattern. The detector identifies the encoding scheme used to encode the text based on the corresponding sub-pattern of the aggregate pattern. For each domain name covered by the aggregate pattern, the detector decodes the text at the location in the domain name indicated by the aggregate pattern according to a decoding scheme corresponding to the identified encoding scheme. To illustrate, if the aggregate pattern indicates that the second component of the covered domain names comprise ASCII encoded text, the detector applies ASCII decoding to the second component of each covered domain name.

At block 325, the detector prompts a language model to determine if the decoded text is meaningful. The detector aggregates the decoded text across domain names to create a single string comprising the decoded text before prompting a language model such as an LLM to evaluate the decoded text. The detector can be configured with a prompt template that comprises a task instruction to evaluate provided text to determine if it is meaningful. The task instructions can indicate that the text should be evaluated for additional qualities related to whether the text is meaningful, such as whether the text is legible and/or printable. The task instructions can also specify a format for the response, such as a yes/no answer as to whether the text is meaningful, printable, and legible. The detector inserts the decoded text into the prompt template to generate a prompt that it submits to the language model (e.g., via an API of the language model).

At block 327, the detector indicates the decoded text and whether the decoded text is meaningful in the analysis results. The detector inserts in the analysis results the decoded text and the verdict by the language model as to whether the text is meaningful.

At block 329, the detector indicates the aggregate pattern in the analysis results. The detector inserts the aggregate pattern that covers the detected domain name into the analysis results.

At block 331, the detector provides the analysis results. The analysis results comprise an indication of whether the domain name matched a known DNS tunneling pattern, the aggregate pattern, and whether the domain name had text encoded therein that is meaningful. The detector can generate a notification or report comprising the analysis results, store the analysis results in a database, etc. to provide the analysis results. The aggregate pattern may also be stored for subsequent pattern matching for DNS tunneling detection if the aggregate pattern was determined to be indicative of DNS tunneling (e.g., based on encoded text being meaningful).

FIG. 4 is a flowchart of example operations for generating a pattern from a domain name. The example operations assume that the detector has identified a domain name in DNS traffic. For instance, the domain name pattern generation described in FIG. 3A at each of blocks 307 and 315 can be implemented with the example operations.

At block 401, the detector parses the domain name into components. The detector can parse the domain name into components as separated by a dot separator. To illustrate, the domain name “foo.bar.217.example.com” will be parsed into its individual components “foo”, “bar”, “217”, “example”, and “com”.

At block 402, the detector initializes a pattern with the original components of the domain name. The initialized pattern comprises each component identified as a result of parsing the domain name.

At block 403, the detector replaces a root domain in the pattern with an indication of a root domain type. Since root domains known to be malicious (e.g., associated with DNS tunneling) should be detected prior to domain name analysis performed by the detector, the root domain of the domain name can be abstracted for the purpose of analyzing subdomains of the domain name through pattern generation. The detector determines the components corresponding to the root domain of the domain name (e.g., based on locations of components within the domain name relative to a TLD) and includes in the initialized pattern an indication of the root domain type. With reference to the previous example, the pattern for “foo. bar.217.example.com” can be updated to “foo. bar.217.< root>” based on determining that “example” and “com” are the components of the domain name that comprise a TLD and the preceding component.

At block 405, the detector begins iterating over components in the pattern.

The detector iterates over the remaining components of the domain name that are not encompassed by the root domain.

At block 407, the detector determines if the component matches a defined type. The detector can be configured with a plurality of regular expressions corresponding to component types. Examples of component types include sequences of decimal values, sequences of hexadecimal values, and alphanumeric character strings. If the component matches a defined type, operations continue at block 409. If not, operations continue at block 411.

At block 409, the detector replaces the component in the pattern with an indication of the component type and its length. The detector generates a tag, label, etc. that indicates the component type and length. For instance, referring to the example above, the components “bar” and “217” can be replaced with the respective tags “<alpha:3>” and “<num:3>” in the pattern.

At block 411, the detector determines if there is an additional component in the pattern. If there is another component remaining, operations continue at block 405. If not, operations are complete, and the pattern that results can be used for analysis. For instance, with reference to FIGS. 3A-3B, operations can proceed to block 309 or block 317.

FIGS. 5A-5B are a flowchart of example operations for aggregating patterns across domain names to generate an aggregate pattern covering the domain names. The example operations assume that the detector has generated a plurality of patterns corresponding to domain names that have a root domain in common. For instance, the pattern aggregation described in FIG. 3B at block 319 can be implemented with the example operations. The example operations may not be performed if the detector does not retrieve any passive DNS data for domain names sharing a root domain with a detected domain name as described above.

At block 501, the detector initializes an aggregate pattern. The detector can initialize an aggregate pattern comprising a number of sub-patterns equivalent to the number of sub-patterns in each of the generated patterns. The aggregate pattern can be initialized with default or null values in the place of each pattern component corresponding to a sub-pattern.

At block 502, the detector begins iterating over sub-patterns corresponding to a location in the domain names covered by the patterns. To illustrate, for an example set of domain name patterns “<num:1>.<hex:23>”, “<num:1>.<hex:20>”, and “<num:2>.<hex:13>”, the detector processes the first components in the domain names corresponding to the respective sub-patterns “<num:1>”, “<num:1>” and “<num:2>” at a first iteration and the second components in the domain names corresponding to the respective sub-patterns “<hex:23>”, “<hex:20>”, and “<hex:13>” at a second iteration.

At block 503, the detector determines if the sub-patterns indicate that the components of the corresponding domain names comprise a numeric value. The detector determines if each sub-pattern across patterns indicates a type corresponding to a numeric value. If so, operations continue at block 505. If not, operations continue at block 513 of FIG. 5B.

At block 505, the detector compares the components of the domain names corresponding to the sub-pattern. The detector compares the components to determine if the numeric value is a constant value across domain names or if the numeric value represents a counter value that increments by one across domain names. The numeric value can be identified as corresponding to a counter increasing by one across domain names because the domain names were arranged in chronological order.

At block 507, the detector determines if the components are a constant value or a counter value. If the components are a counter value (i.e., a value that increments by one across components), operations continue at block 509. If the components are a constant value, operations continue at block 511. If the components are neither, such as if the components comprise two or more different values that do not correspond to a counter, operations continue at block 518 of FIG. 5B.

At block 509, the detector updates the corresponding sub-pattern of the aggregate pattern with an indication of a counter value. The detector updates the sub-pattern in the location corresponding to the components of the domain names comprising the counter value with a sub-pattern indicating that the respective components covered by the aggregate domain name comprise a counter value, such as with a label or tag indicating a counter value type, and the length of the components forming the counter (e.g., “<counter:1>”or “<counter:N>”). Operations continue at block 521 of FIG. 5B.

At block 511, the detector updates the corresponding sub-pattern of the aggregate pattern with the constant value. The detector updates the sub-pattern in the location corresponding to the components of the domain names comprising the constant value with a sub-pattern that simply indicates the constant value. Operations continue at block 521 of FIG. 5B.

At block 513, the detector determines if the types of the sub-patterns may correspond to encoded text. The detector has been configured with indications of one or more component types represented in a sub-pattern that may correspond to encoded text, such as hexadecimal components and alphanumeric components. If the sub-patterns indicate that the corresponding components are one of these types that may correspond to encoded text, operations continue at block 515. If not, operations continue at block 518.

At block 515, the detector evaluates the corresponding components of the domain names based on patterns defined for encoding schemes. The detector uses one or more encoding detection patterns (e.g., regular expressions) for identifying encoded text. The detector evaluates the respective components of each of the domain names against the encoding detection pattern(s).

At block 517, the detector determines if a match was found across the domain name components. If the domain name components matched an encoding detection pattern, the domain name components can be determined to correspond to text encoded according to the encoding scheme corresponding to the matching pattern. If there was no match, operations continue at block 518. If the components matched a pattern corresponding to an encoding scheme, operations continue at block 519.

At block 518, the detector updates the aggregate pattern with a representation of the sub-patterns. The representation of the sub-patterns may comprise the type and length indicated in each of the sub-patterns if the sub-patterns are of the same type and length. If the sub-patterns are of a same type but varying lengths, the representation of the sub-patterns may comprise the type and an indication of a variable length. If the sub-patterns are of varying types, the representation of the sub-patterns can indicate a wildcard value or can otherwise indicate that the corresponding components of the covered domain names vary across domain names.

At block 519, the detector updates the corresponding sub-pattern of the aggregate pattern with an indication of the encoding scheme. The indication of the encoding scheme is an identifier of the encoding scheme for which the match was found across components. The sub-pattern can also indicate the length of the components comprising the text encoded according to the indicated encoding scheme (whether the length is variable or constant).

At block 521, the detector determines if there is an additional sub-pattern across the patterns remaining. If so, operations continue at block 502 of FIG. 5A. If not, operations are complete, and the aggregate pattern that remains can be utilized for analysis of the covered domain names. For instance, operations can proceed to block 321 of FIG. 3B.

The example operations of FIG. 5 describe a case where domain names sharing a root domain for which an aggregate pattern is generated have a same number of components. However, in implementations, domain names sharing a root domain for which the aggregate pattern is generated may have different numbers of components and/or components of different lengths. To address this, implementations can apply majority voting for determining sub-patterns of the aggregate pattern and/or clustering for these domain names using feature vectors of component length. For instance, “foo.1.helloworld.example.com” has a feature vector of [3, 1, 10] (assuming root domains are excluded from the feature vectors since these will be consistent across domain names). The domain names with similar component numbers and component lengths will be clustered with each other. For the clusters with a domain name number higher than a threshold, majority voting can be applied to determine an aggregate pattern for domain names represented in the cluster based on a majority vote across components or component abstractions at each component location in the domain names.

FIG. 6 is a flowchart of example operations for analyzing a DNS record for indicators of DNS tunneling. Text can be encoded in certain types of DNS records to carry out DNS tunneling attacks. The detector also analyzes select types of DNS records identified in DNS responses to facilitate DNS tunneling detection.

At block 601, the detector detects a DNS response comprising a DNS record. The DNS response can be forwarded to the detector by a cybersecurity appliance, for instance.

At block 603, the detector determines a type of the DNS record. The detector determines the value of the type field of the DNS record to determine its type.

At block 605, the detector determines if the DNS record is one of a set of specified types. The detector is configured with a set of one or more DNS record types that should be evaluated further for DNS tunneling. For instance, the specified types can include TXT records, SRV records, A records, and/or AAAA records. If the DNS record is one of the specified types, operations continue at block 607. If not, operations are complete, and the DNS record may be permitted to pass by the cybersecurity appliance.

At block 607, the detector evaluates contents of the DNS record based on patterns for detecting encoded text. The detector has been configured with one or more patterns (e.g., regular expressions) corresponding to one or more encoding schemes by which text that may be encoded can be detected. Examples of encoding schemes include Base32, Base64, and ASCII. To illustrate, the regular expression \hat{ }[a-zA-Z0-9+/]+={0,2}$ can be utilized to match Base64 encoding within the domain names. The detector evaluates the value stored in the DNS record based on the patterns for detecting encoded text.

At block 609, the detector determines if a match was found. If the contents of the DNS record matched a pattern corresponding to an encoding scheme, operations continue at block 611. If there was no match, operations are complete.

At block 611, the detector decodes the encoded text. The detector decodes the encoded text included as a value in the DNS record with a decoding technique that corresponds to the encoding technique identified as a result of matching the DNS record contents to a pattern.

At block 613, the detector prompts a language model to determine if the decoded text is meaningful. As with evaluating text of domain name described above, the detector can be configured with a prompt template that comprises a task instruction to evaluate provided text to determine if it is meaningful. The task instructions can indicate that the text should be evaluated for additional qualities related to whether the text is meaningful, such as whether the text is legible and/or printable. The task instructions can also specify a format for the response, such as a yes/no answer as to whether the text is meaningful, printable, and legible. The detector inserts the decoded text into the prompt template to generate a prompt that it submits to the language model and obtains in response a verdict of whether the text is meaningful.

At block 615, the detector indicates the decoded text and whether the decoded text is meaningful. The detector can generate a notification, report, etc. indicating the results of evaluating the DNS record that comprise the decoded text and the response from the language model indicating whether the decoded text is meaningful, store results of analyzing the DNS record contents, etc.

The example operations of FIG. 6 are described for cases where a DNS response includes a single DNS record. Implementation can detect DNS responses comprising multiple DNS records. In these cases, if two or more of the DNS records are of one of the designated types, the detector can concatenate values of the DNS records that match a same encoding scheme, decode the aggregated values to generate decoded text, and prompt a language model to determine if the decoded text is meaningful.

Variations In this description, the disclosed DNS tunneling detector is described as determining if text is meaningful based on prompting a language model with the text and a task instruction. Implementations can also or instead perform semantic analysis of text to determine if the text is meaningful. For instance, the detector can analyze the text based on string searching to determine if the word(s) included therein are dictionary-defined, with punctuation and sentence structure analysis, based on grammar analysis, and the like.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in FIG. 4 can be performed in parallel or concurrently across domain names. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

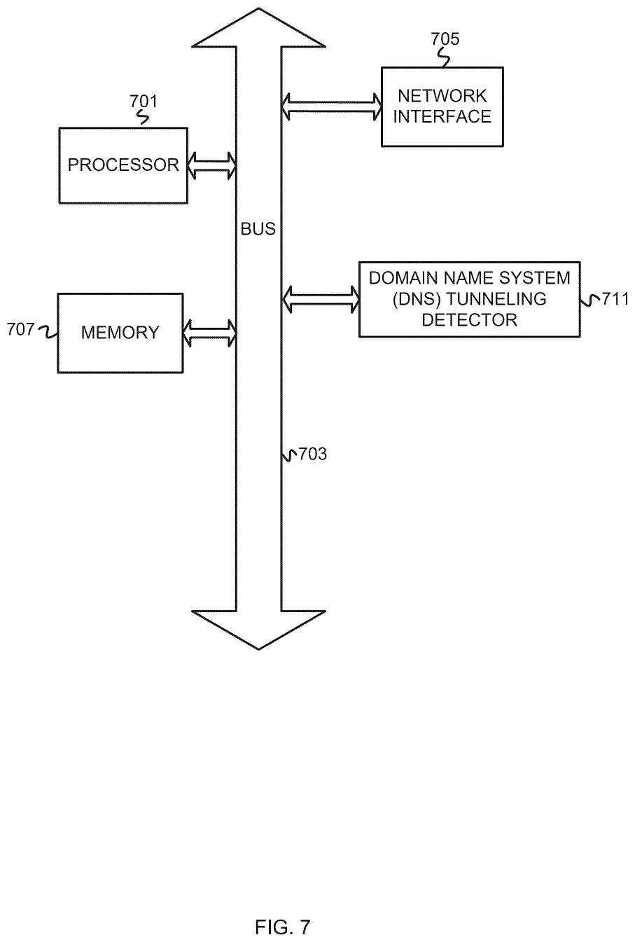

FIG. 7 depicts an example computer system with a DNS tunneling detector. The computer system includes a processor 701 (possibly including multiple processors, multiple cores, multiple nodes, and/or implementing multi-threading, etc.). The computer system includes memory 707. The memory 707 may be system memory or any one or more of the above already described possible realizations of machine-readable media.

The computer system also includes a bus 703 and a network interface 705. The system also includes DNS tunneling detector 711. The DNS tunneling detector 711 analyzes detected DNS traffic for indicators of DNS tunneling. The DNS tunneling detector 711 analyzes domain names identified in DNS requests and responses to determine if the subdomains of the domain names are reflective of DNS tunneling based in part on whether the subdomains comprise encoded text that is meaningful. The DNS tunneling detector 711 analyzes certain types of DNS records identified in DNS responses to determine if the DNS records comprise encoded text that is meaningful. Any one of the previously described functionalities may be partially (or entirely) implemented in hardware and/or on the processor 701. For example, the functionality may be implemented with an application specific integrated circuit, in logic implemented in the processor 701, in a co-processor on a peripheral device or card, etc. Further, realizations may include fewer or additional components not illustrated in FIG. 7 (e.g., video cards, audio cards, additional network interfaces, peripheral devices, etc.). The processor 701 and the network interface 705 are coupled to the bus 703. Although illustrated as being coupled to the bus 703, the memory 707 may be coupled to the processor 701.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
identifying a first domain name indicated in a detected Domain Name System (DNS) query;
generating a pattern that covers the first domain name and an additional plurality of domain names corresponding to a root domain of the first domain name, wherein the plurality of domain names is identified in passive DNS data obtained for a first timeframe, wherein generating the pattern comprises,
for each component of the first domain name and the plurality of domain names, determining if the component comprises encoded text; and
based on determining that the component comprises encoded text, indicate within the pattern a location of text encoded in domain names covered by the pattern and an indication of a corresponding first encoding scheme;
decoding the text encoded in the first domain name and the plurality of domain names at the location indicated in the pattern with a decoding scheme corresponding to the first encoding scheme;
determining if the decoded text of the first domain name and the plurality of domain names is meaningful; and
indicating the pattern and whether the decoded text is meaningful.

2. The method of claim 1, wherein determining if the decoded text is meaningful comprises prompting a first language model with the decoded text and a task instruction to determine if the decoded text is meaningful and determining if the decoded text is meaningful based on a response to prompting the first language model.

3. The method of claim 1 further comprising:
based on detecting a DNS response, determining that a DNS record included in the DNS response is of a designated type;
determining if contents of the DNS record are encoded;
based on determining that the contents of the DNS record are encoded according to a second encoding scheme, decoding the contents of the DNS record with a decoding scheme corresponding to the second encoding scheme; and
determining if the decoded contents of the DNS record are meaningful based on prompting a second language model with the decoded contents and a task instruction to determine if text of the decoded contents are meaningful.

4. The method of claim 3, wherein determining that the DNS record included in the DNS response is of a designated type comprises determining that the DNS record is a TXT record, an SRV record, an A record, or an AAAA record.

5. The method of claim 1, wherein generating the pattern further comprises, parsing the first domain name and each the plurality of domain names into a plurality of components;
determining abstracted representations of at least a subset of the plurality of components of each of the plurality of domain names and the first domain name; and
aggregating the abstracted representations of components across the plurality of domain names and the first domain name, wherein the pattern covering the first domain name and the plurality of domain names comprises the aggregated abstracted representations.

6. The method of claim 5, wherein determining the abstracted representations of at least the subset of the plurality of components comprises determining at least one of types of the subset of the plurality of components and lengths of each of the subset of the plurality of components, wherein the pattern indicates the at least one of types and lengths of each of the subset of the plurality of components.

7. The method of claim 5, further comprising arranging the plurality of domain names identified in the passive DNS data chronologically, wherein aggregating the abstracted representations comprises aggregating the abstracted representations across the first domain name and the plurality of domain names and the first domain name arranged in chronological order.

8. The method of claim 1, wherein determining that the component comprises encoded text comprises matching the component to a regular expression corresponding to the first encoding scheme.

9. The method of claim 1, further comprising determining if the first domain name matches a pattern known to correspond to DNS tunneling and indicating the match to the pattern known to correspond to DNS tunneling with the generated pattern and whether the decoded text is meaningful.

10. One or more non-transitory machine-readable media having program code stored thereon, the program code comprising instructions to:
based on detection of Domain Name System (DNS) traffic, identify a first domain name indicated in the DNS traffic;
generate a pattern covering a plurality of domain names that includes the first domain name based on categorization of components of the plurality of domain names, wherein additional ones of the plurality of domain names are identified in passive DNS data obtained for a first timeframe, wherein the instructions to generate the pattern comprise instructions to,
determine that a first component of each of the plurality of domain names is encoded according to a first encoding scheme; and
categorize the first component of each of the plurality of domain names as encoded text corresponding to the first encoding scheme;
decode components of each of the plurality of domain names categorized as corresponding to the first encoding scheme to obtain first decoded text;
determine whether the first decoded text is meaningful; and
indicate the pattern representing the first domain name and, based on a determination that the first decoded text is meaningful, a verdict that the first decoded text is meaningful.

11. The non-transitory machine-readable media of claim 10, wherein the instructions to determine whether the first decoded text is meaningful comprise instructions to prompt a first language model with the first decoded text and a task instruction to determine if the first decoded text is meaningful and determine whether the first decoded text is meaningful based on a response to prompting the first language model.

12. The non-transitory machine-readable media of claim 10, wherein the program code further comprises instructions to:
determine that the DNS traffic comprises a DNS record of a designated type;
determine whether the DNS record comprises encoded text;
based on a determination that the DNS record comprises encoded text, decode the encoded text of the DNS record to obtain second decoded text; and
determine whether the second decoded text is meaningful based on prompting a second language model with the second decoded text and a task instruction to determine if the second decoded text is meaningful, wherein the instructions to indicate the pattern representing the first domain name and whether the second decoded text is meaningful further comprise instructions to indicate the second decoded text and whether the second decoded text is meaningful.

13. The non-transitory machine-readable media of claim 11, wherein the instructions to determine that the DNS traffic comprises a DNS record of a designated type comprise instructions to determining that the DNS traffic comprises a DNS record indicating a type of TXT, SRV, A, or AAAA.

14. The non-transitory machine-readable media of claim 10, wherein the instructions to generate the pattern further comprise instructions to, arrange the plurality of domain names in chronological order based at least partly on the passive DNS data;
parse each of the plurality of domain names into a plurality of components;
for each of the plurality of domain names, categorize at least a second component of the domain name based on at least one of a type of the second component and a length of the second component; and
aggregate categorizations of components across the plurality of domain names arranged in chronological order, wherein the pattern comprises the aggregated categorizations.

15. An apparatus comprising:
a processor; and
a machine-readable medium having instructions stored thereon that are executable by the processor to cause the apparatus to, based on detection of a Domain Name System (DNS) query, identify a first domain name indicated in the DNS query;
generate a pattern that covers the first domain name and an additional plurality of domain names corresponding to a root domain of the first domain name, wherein the plurality of domain names is identified in passive DNS data obtained for a first timeframe, wherein the instructions to generate the pattern comprise instructions to,
for each component of the first domain name and the plurality of domain names, determine if the component comprises encoded text; and
based on a determination that the component comprises encoded text, indicate within the pattern a location of text encoded in domain names covered by the pattern and an indication of a corresponding first encoding scheme;
decode the text encoded in the first domain name and the plurality of domain names at the location indicated in the pattern with a decoding scheme corresponding to the first encoding scheme to obtain first decoded text;
determine if the first decoded text is meaningful; and
indicate the pattern and whether the first decoded text is meaningful.

16. The apparatus of claim 15, wherein the instructions executable by the processor to cause the apparatus to determine if the first decoded text is meaningful comprise instructions executable by the processor to cause the apparatus to prompt a first language model with the first decoded text and a task instruction to determine if the decoded text is meaningful and determine if the first decoded text is meaningful based on a response to prompting the first language model.

17. The apparatus of claim 15, further comprising instructions executable by the processor to cause the apparatus to:
based on detection of a DNS response, determine that a type of DNS record included in the DNS response is one of a plurality of designated types;
determine if contents of the DNS record comprise encoded text;
based on a determination that the contents of the DNS record comprise encoded text, decode the contents of the DNS record to obtain second decoded text; and
determine if the second decoded text is meaningful based on prompting a second language model with the second decoded text and a task instruction to determine if the second decoded text are meaningful,
wherein the instructions executable by the processor to cause the apparatus to indicate the pattern and whether the second decoded text is meaningful comprise instructions executable by the processor to cause the apparatus to indicate whether the second decoded text is meaningful.

18. The apparatus of claim 17, wherein the plurality of designated types comprises one or more of TXT records, SRV records, A records, and AAAA records, and wherein the instructions executable by the processor to cause the apparatus to determine that the type of the DNS record is one of the plurality of designated types comprise instructions executable by the processor to cause the apparatus to determine that the DNS record is a TXT record, an SRV record, an A record, or an AAAA record.

19. The apparatus of claim 15, wherein the instructions executable by the processor to cause the apparatus to generate the pattern comprise instructions executable by the processor to cause the apparatus to:
parse each of the first domain name and the plurality of domain names into a plurality of components to generate a plurality of parsed domain names;
determine abstracted representations of at least a first component of each of the plurality of parsed domain names; and
aggregate the abstracted representations of components of the plurality of parsed domain names, wherein the pattern comprises the aggregated abstracted representations.

20. The apparatus of claim 19, further comprising instructions executable by the processor to cause the apparatus to arrange the first domain name and the plurality of domain names in the passive DNS data chronologically, wherein the instructions executable by the processor to cause the apparatus to aggregate the abstracted representations of components of the plurality of parsed domain names arranged chronologically.
